(19) United States
(12) Patent Application Publication
(10) Pub. No.: US 2023/0255213 A1
(43) Pub. Date: Aug. 17, 2023

(54) ARTICLES AND METHODS FOR HANDLING FOOD

(71) Applicant: SFC GLOBAL SUPPLY CHAIN, INC., Marshall, MN (US)

(72) Inventors: Peter CLARKE, Newtown, CT (US); John Kevin CLAY, Milford, CT (US); Thomas VAN DYK, Ramsey, NJ (US); Justin BROWNE, Marshall, MN (US)

(21) Appl. No.: 18/170,058

(22) Filed: Feb. 16, 2023

Related U.S. Application Data
(60) Provisional application No. 63/311,389, filed on Feb. 17, 2022.

(51) Int. Cl. A21B 3/00; A47J 43/28

(52) U.S. Cl. CPC A21B 3/003; A47J 43/288

(57) ABSTRACT

The present disclosure generally relates to articles and methods for handling food items. In one aspect, an article for receiving or holding a food item comprises: a blade; and a rim extending along at least one side of the blade. In another aspect, a method of handling a food item using an article comprises a blade and a rim extending along at least one side of the blade, the method comprising: gripping or holding a part of the rim by hand; causing the food item to be placed onto the blade; and moving the article containing the food item therein to a desired location.

### CROSS-REFERENCE TO RELATED APPLICATION(S)

This application claims priority to U.S. application Ser. No. 63/311,389, filed on Feb. 17, 2022, the disclosure of which is hereby incorporated by reference in its entirety.

### BACKGROUND

The present disclosure generally relates to articles and methods of using the same for preparing, holding, transferring, serving, or handling food items.

In the field of food preparation and service such as home, restaurants, food stores, food processing factories, it is desirable to handle food items without having direct contact between the handler and the food items. This desire stems from both a sanitary and a practical need. For example, indirect contact will allow a consumer to take the food item comfortably with a confidence that the food will lack any contamination from those handlers who handled the food items. Such indirect contact will also allow a food product provider to handle food items he or she might otherwise not be able to handle, such as excessively hot food products or food items that are awkward in shape.

### SUMMARY

In one aspect, the present disclosure provides an article for receiving or holding a food item. In one example, an article comprises: a blade; and a rim extending along at least one side of the blade. In some embodiments, the article is a pizza peel.

The blade may be flat or substantially flat. The article may have one side, or three sides, or four sides, or five sides. At least one side of the blade may be open.

In some embodiments, the blade of the article comprises two flat sides and two curved sides and the rim follows the shape of the curve on at least one side of the blade. The rim may extend from the curved sides of the blade to an outer edge elevated from the blade, and the rim may form an angle relative to the blade.

In some embodiments, the blade may further comprise a top surface and a bottom surface. The article may further comprise a plurality of projections disposed on the top surface, the bottom surface, or both. The article may further comprise a plurality of recesses disposed on the top surface, the bottom surface, or both. The article may further comprise a protective coating or a decorative coating disposed on at least a portion of the top surface, the bottom surface, or both.

The rim of the article may extend along a portion of at least two sides of the blade. The rim may have a first height and a second height relative to the blade, and the first height and the second height are not the same. The rim may further comprise a depression, a plurality of projections, a plurality of recesses, or a combination thereof.

In some embodiments, the article further comprises a lip extending from the top edge of the rim. The lip may be substantially parallel to the blade.

In some embodiments, the article is made of cellulose, paper, paperboard, molded paper, polymer, post-consumer recycled paper or paperboard, post-consumer recycled polymer, aluminum, or a mixture thereof. In some embodiments, the article comprises a wet strength agent or polymer. In some embodiments, the article is configured to hold a wet food item of at least 8 oz without substantial deflection, deformation, or breakage.

In some embodiments, the article is intended for single use.

In another aspect, the present disclosure provides a pizza peel. In one example, a pizza peel comprises: a blade comprising a top surface, and a bottom surface; a plurality of projections or recesses on the top surface, the bottom surface, or both; and a rim extending along at least two sides of the blade. In some embodiments, the rim extends along a portion of at least four sides of the blade.

In some embodiments, the pizza peel is configured to hold a wet food item of at least 24 oz without substantial deflection, deformation, or breakage.

In another aspect, the present disclosure provides a method of handling a food item using an article according to the present disclosure, the article comprising a blade, and a rim extending along at least one side of the blade. In one example, a method comprises: gripping/holding a part of the rim by hand; causing the food item to be placed onto the blade; and moving the article containing the food item therein to a desired location.

In some embodiments, the present disclosure provides a method of extending the user's reach, such as transferring the pizza from the blade to the back of a hot oven.

In some embodiments, the method further comprises: cutting the food item off from a larger food using a part of the blade of the article, and moving the food item using the article.

The method may further comprise: sloping the article to cause the food item placed therein to slide off from the article through an open side of the blade to the desired location.

In some embodiments, the steps of the method are performed by one hand.

In some embodiments, the food item is free from contacting the hand throughout the operation. In some embodiments, the food item is a pizza or a part thereof or a pizza slice.

### BRIEF DESCRIPTION OF THE DRAWINGS

FIG. 1 is a schematic view showing one example article 10 with a food item placed therein, according to the present disclosure.

FIG. 2A is a schematic perspective view of one example article 12 of the present disclosure.

FIG. 2B is a top view of the example article according to FIG. 2A.

FIG. 2C is a side view of the example article according to FIG. 2A.

FIG. 2D is a cross-sectional view article taken along line A-A′ of the example article according to FIG. 2B.

FIG. 2E is a cross-sectional view of the example article taken along line B-B′ according to FIG. 2B.

FIG. 3 is a top view of another example article 14 according to the present disclosure.

FIG. 4 is a top view of yet another example article 16 according to the present disclosure.

FIG. 5 is a top view of a further example article 18 according to the present disclosure.

FIG. 6 is flow chart of one example method 60 according to the present disclosure.

### DETAILED DESCRIPTION

Various embodiments will be described in detail with reference to the drawings, wherein like reference numerals represent like parts and assemblies. Reference to various embodiments does not limit the scope of the claims attached hereto. Additionally, any examples set forth in this specification are not intended to be limiting and merely set forth some of the many possible embodiments for the appended claims.

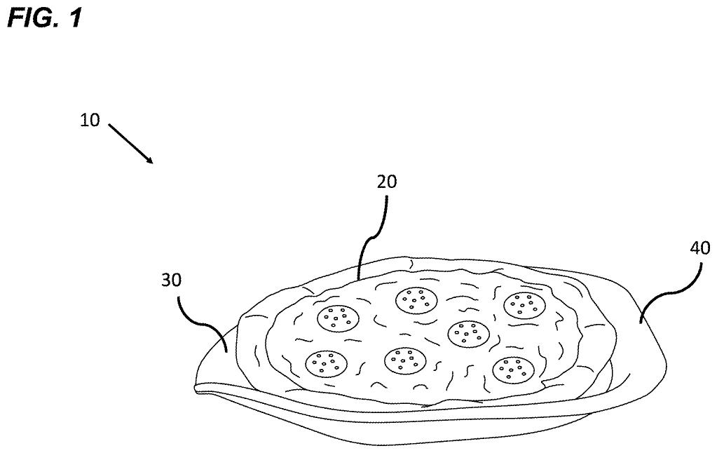

In one aspect, the present disclosure relates to an article or device or tool for handing food. FIG. 1 is a schematic view showing one example article 10 according to the present disclosure. The article 10 is generally used for preparing, handling, relocating, or operating a food item 20. In the illustrated example, the article 10 includes a receiving member 30, a protecting member 40, and optionally an additional handling member 50. In some embodiments, the article 10 may be a single-piece integrated article (e.g., manufactured by pressed paper or pulp processing, injection molding, thermoforming, rotational molding, or other method), wherein the receiving member 30, the protecting member 40, and the handling member 50 are jointly formed and inseparable from each other. The receiving member 30 is configured to receive, accommodate, support, and hold the food item 20 disposed thereon. The protecting member 40 is configured to protect and partially contain the food item 20 from sliding off from the receiving member 30. The protecting member 40 is further configured for a user to grip, hold, capture, grasp, position, and handle the article 10 by fingers or hand(s). The optional handling member 50 may provide users with additional structure to handle the article 10.

Also shown in FIG. 1 is the food item 20 (not included in the article 10). The food item 20 may be any food product that is uncooked, cooked, semi-cooked, or ready-to-serve. Non-limiting examples of the food item 20 include pizza, pizza slice, cake, donut, pie, bread, pasta, lasagna, etc. The present article is particularly useful in handling hot, cheesy, oily, wet, soft, or fragile foods that are difficult to handle by hands.

The article 10 of the present disclosure can serve a variety of purposes, for example, as a utensil, a spatula, a container, a serving platter, a cutter, a pizza peel, etc. Non-limiting examples of use of the article 10 include food preparation, e.g., dividing a food item into portions; receiving, accommodating, containing, or holding a food item for serving or storage; moving a food item from one location to another location; relocating or transferring an uncooked item to an appliance or a cooked item from an appliance to desired location; extending the user's reach when transferring an item to a hot oven; protecting the food from contamination; protecting an item from damage during shipping; serving as product packaging; etc.

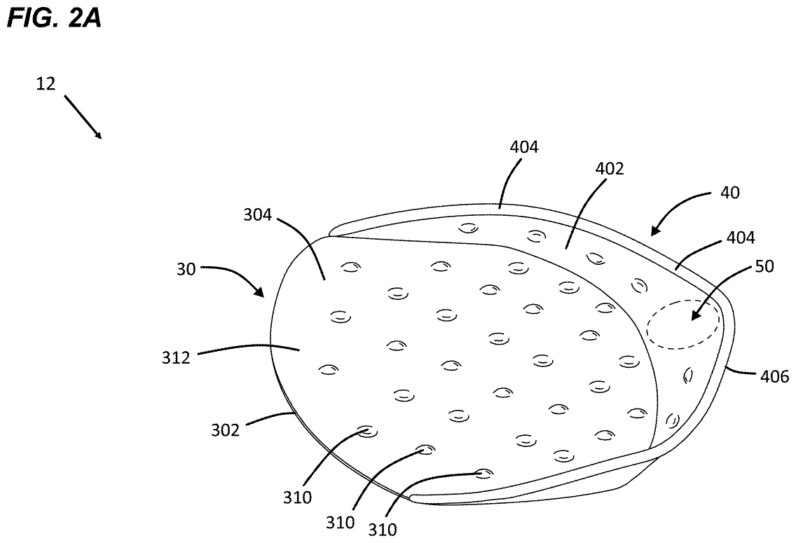

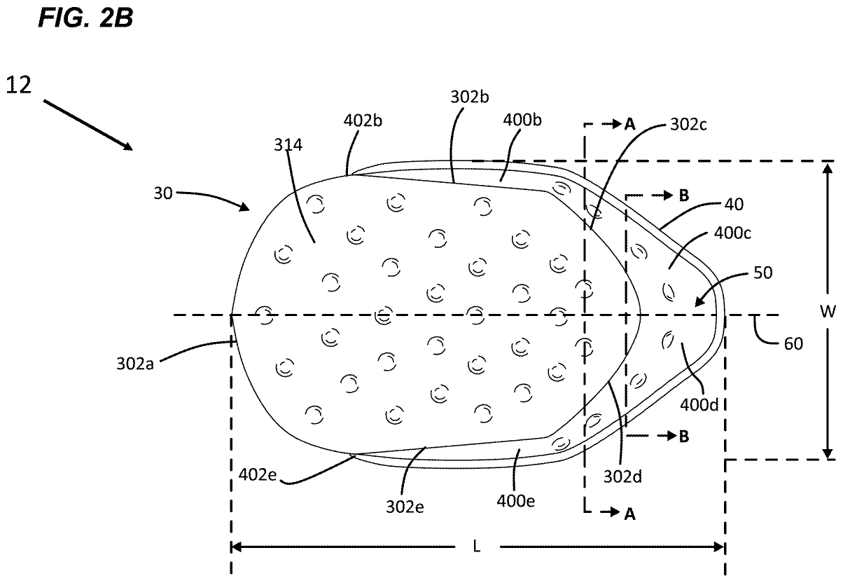

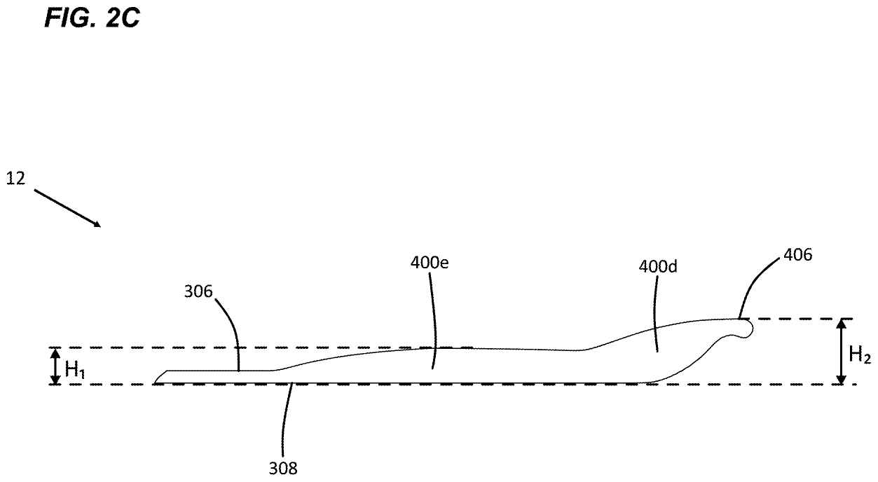

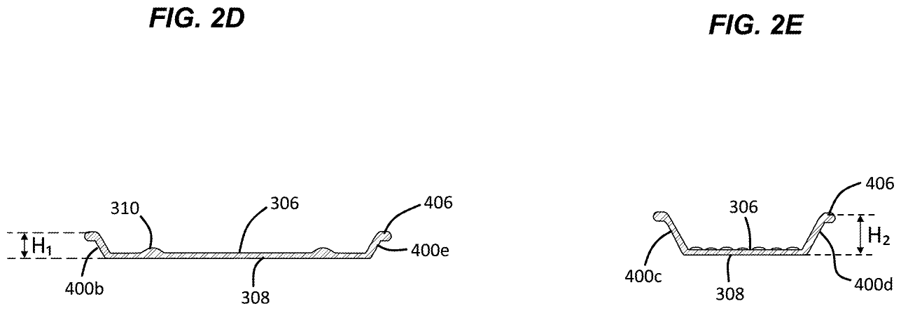

Now referring to FIGS. 2A-2E, one particular example 12 of the article 10 and various aspects of the example 12 will be illustrated and described. FIG. 2A is a perspective view of the article 12. FIG. 2B is a top view of the article 12. FIG. 2C is a side view of the article 12. FIG. 2D is a cross-sectional view along the line A-A′. FIG. 2E is a cross-sectional view along the line B-B′. In the illustrated example, the article 12 includes a receiving member 30 and a protecting member 40. The receiving member 30 is substantially flat and aligned with a plane. The receiving member 30 may have various geometric configurations, e.g., round or substantially round or partially round, elliptical or substantially elliptical, square or substantially square, rectangular or substantially rectangular, poly-lateral, or a combination of one or more shapes.

In some embodiments, the receiving member 30 includes a blade 300. The blade 300 has a major portion 314 and at least one outer edge or side 302 surrounding the major portion 314. The major portion 314 is substantially flat. In some embodiments, the blade 300 has more than one side, e.g., at least 2, at least 3, at least 4, or at least 5 sides. The side(s) or a part thereof may have an outline that is straight or curved. At least one side 302 is flat and open. At least one side 302 is curved upwardly. Each of the side 302 has a length that can vary, and the blade 300 has a total length of the flat side(s) sufficient to provide an entrance for the food item to pass therethrough.

In the illustrated example, the blade 300 has five sides, 302a, 302b, 302c, 302d, and 302e. Each of the sides 302a, 302b, 302c, 302d, and 302e may independently have a curved or a straight or a substantially straight outline. In one embodiment, the side 302a has a curved outline and the sides 302b, 302c, 302d, and 302e each have a straight or substantially straight outline. The side 302a is flat and open; while the sides 302b, 302c, 302d, and 302e are curved upwardly. In some embodiments, at least a portion of the side 302a is somewhat sharp and capable of cutting through a food item such as a pizza or a cake or a pie and divide the food item into portions. As an example, a user may use the side 302a to cut off a piece of cake or pie from a whole cake or pie, without dragging any portion of the immediately adjacent piece away from it. In some embodiments, at least one side 302 is open and sufficiently flat so that a food item, e.g., a pizza slice, can easily slide in the article 10 through the flat/open side 302 without obstacle.

The blade 300 has a size that may vary depending the type, size, and/or weight of the food item to be received and held therein. In the illustrated example, the blade 300 has a length (L) and a width, each from about 3 to about 20 inches, or from about 5 to about 15 inches, or from about 7 to about 12 inches, or from about 8 to about 10 inches. In some embodiments, the article 10 is configured to receive a food item having a weight from about 1 to about 30 oz, or from about 5 to about 28 oz, or from about 10 to about 25 oz, or from about 15 to about 25 oz, or from about 18 to about 24 oz. On average there are 6 slices per small (8-10 inch diameter) round pizza, 8 slices per medium (12 inch diameter) round pizza, 10 slices per large (14 inch diameter) round pizza and 12 slices per extra-large (16-18 inch diameter) round pizza. Thus, in some embodiments, the present article would be configured to accommodate a whole round pizza in any size, or a part thereof, or a slice thereof.

The blade 300 generally includes a top surface 306 and a bottom surface 308. The blade 300 may be made of paperboard or pressed board. In some embodiments, the thickness of the paperboard or pressed board may be from about 5 points to about 30 points; from about 10 points to about 30 points; from about 15 points to about 30 points. In a preferred embodiment, the thickness of the blade 300 made of paperboard or pressed paperboard may be from about 12 points to about 26 points. In some embodiments, the blade 300 is made of a plastic sheet. In some embodiments, the thickness of the plastic sheet may be from about 5 mils to about 50 mils, or from about 10 mils to about 40 mils, or from about 15 mils to about 30 mils. In a preferred embodiment, the thickness of the blade 300 made of plastic is from about 12 mils to about 26 mils. The blade is preferably a sufficient thickness that a consumer can either cut the food item 20 directly on the blade or eat the food item 20 off of the blade 300 using utensils without cutting through the bottom of blade 300. In some embodiments, the blade 300 further comprises a surface pattern 310 on the top surface 306 or the bottom surface 308 or both. The surface pattern 310 may include a plurality of projections, or a plurality of recesses, or a mixture of both. The projections and the recesses of the top surface 306 are configured to reduce the contact area of the top surface 306 to the food item placed thereon, to prevent the food item from sticking to the top surface 306 or to facilitate removal of the food item from the article 10 when needed. The projections also create a small gap between the bottom of the food item 20 and the top surface 306 of the blade 300. This gap allows for air circulation which assists in cooling the food item 20 or removing moisture from the food item 20 so that the food item does not become soggy. In some embodiments, the article 10 comprises a coating 312 disposed on at least a part of the top surface 306 or at least some the projections or recesses thereof. The coating 312 may comprise a protective coating such as a water-resistant material or an oil-resistant material that is compatible with food contact. The coating 312 may prevent water, juice, oil, or liquid of the food item from penetrating the blade 300 and/or improve the durability and use life of the article 10. In some embodiments, the coating 312 comprises a decorative coating such as wood grain, branding, a graphic treatment, a printable element such as a mark, a sign, or a temperature sensitive ink that can reveal a visual message.

In some embodiments, the protecting member 40 includes a rim 400 that is joined to at least a portion of an outer edge or side 302 of the blade 300. In the illustrated example, the rim 400 extends from at least one side 302 of the blade 300 to a top outer edge 404 of the rim 400. In particular, the rim 400 includes a plurality of portions 400b, 400c, 400d, and 400e, extending along at least a segment of each of the side 302b, 302c, 302d, and 302e respectively and following the upward curve of each side. In some embodiments, each of the rim portion extends at an angle, e.g., about 20° to about 90° , relative to the top surface 306 of the blade 300. In some embodiments, the top outer edge 404 of the rim portion 400b and/or 400e slopes downward in height so that it merges with the top surface 306 of the blade 300 at a merge point 402b and/or 402e. In some embodiments, the rim 400 has a first height (H1) and a second height (H2) relative to the top surface 306 of the blade 300. In the illustrated example, the rim portions 400b and 400e have a height of H1, and the rim portions 400c and 400d have a height of H2. In some embodiments, H1 and H2 are substantially the same. In other embodiments, H1 and H2 are not the same, e.g., H2 is more than Hl. H1 and H2 may each have a value from about 0.2 to about 2 inches, or from about 0.5 to about 1.5 inches, or from about 0.8 to about 1.2 inches.

Similar to the blade 300, the rim 400 may be made of paperboard or pressed board. In some embodiments, the thickness of the paperboard or pressed board may be from about 5 points to about 30.0 points; from about 10 points to about 30 points; from about 15 points to about 30 points. In one embodiment, the thickness of the rim 400 may be from about 12 points to about 26 points. In some embodiments, the rim 400 is made of a plastic sheet. In some embodiments, the thickness of the plastic sheet may be from about 5 mils to about 50 mils, or from about 10 mils to about 40 mils, or from about 15 mils to about 30 mils.

In some embodiments, the rim 400 includes at least one rib 408 extending in a direction from the top outer edge 404 to the side 302. As shown in FIG. 2B, the rim 400 may include a plurality of ribs 408a and 408b (collectively as 408) along the length of the rim 400. Each of the ribs 408a and 408b joints with two adjacent rim portions (e.g., 400b and 400c) and the corresponding side 302 of the blade 300. The rib 408 may be relatively thicker than the majority portion of the rim 400. In some embodiments, the rib 408 has a thickness from about 1 millimeter to about 10 millimeters and a width from about 1 millimeter to about 30 millimeters. The rib(s) 408 may provide additional structural integrity and rigidity to the article 10. In particular, the rib(s) 408 may improve stability of the article 10 against pulling force or compression, and minimize injury or deformation of the article 10 during operation or distribution. In addition, the ribs (408) may also provide a certain aesthetic aspect to the overall appearance of the article 10. In some embodiments, the rim 400 includes at least 2, at least 3, at least 4, at least 5, at least 6, at least 7, at least 8, at least 10, or at least 20 ribs 408. In some embodiments, the rim 400 includes 1-20 ribs, 1-10 ribs, 1-6 ribs, 1-4 ribs, or 1-2 ribs.

In some embodiments, the rim 400 optionally includes a surface pattern 410 (such as a plurality of depressions, projections, or recesses) disposed on an inner surface, an outer surface, or both thereof. The surface pattern 410 of the rim and the surface pattern 310 of the blade may be substantially the same or different. In some embodiments, the surface pattern 410 comprises a grip feature (such as a rough pattern) that increases grip for a user to hold the rim 400. In some embodiments, the surface pattern 410 comprises a rigidity feature (such as ribs) that increase the rigidity and weight-bearing capacity of the blade 300.

The rim 400 functions in part as a barrier that contains the food item inside the article 10 and protects the food item from accidentally sliding off therefrom. When the article 10 is included as a part of packaging, the rim 400 also functions to protect the food item 20 from damage during storage and shipping. The rim 400 may also provide a means for a user to hold the article 10 in hand. In the illustrated example, at least a part of the rim portions 400c and/or 400d may be griped or held by fingers of the user, which allows for easy handling and/or one-hand operation.

In some embodiments, the rim 400 optionally includes a grip coating (not shown) disposed on at least a portion of the inner surface (food-facing surface) or the outer surface or both. The grip coating may provide or increase grip for a user to more securely hold or grip the article 10 and protect the article 10 from slipping from the user's hand.

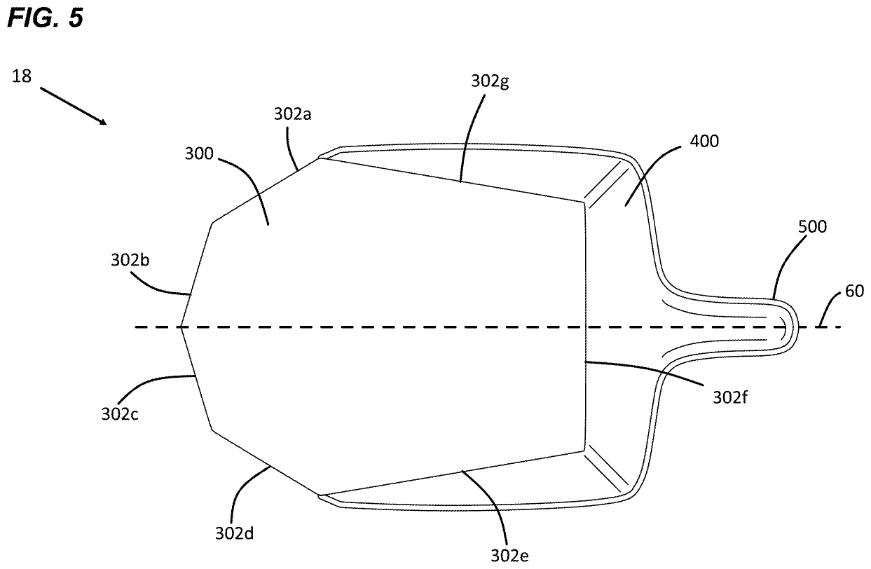

In some embodiments, the article 10 further includes an additional handling member 50 that provides additional security for handling the article 10. The additional handling member 50 may be a part or an extension of the protecting member 40. In the illustrated example, the handling member 50 is an extension of the rim 400 along a center line 60 of the article 10. The handling member 50 has a relatively larger distance between the top outer edge 404 and the side 302, which provides more operating area for a user to grip or hold. In some embodiments, the additional handling member 50 is an elongated handle (as shown in FIG. 5) that protrudes from the rim 400 along the center line 60. The handling member 50 may provide users with additional protection, e.g., allowing for more safely transitioning a food item between the article 10 and a hot oven.

In some embodiments, the article 10 further comprises a lip 406 extending from at least a portion of the top outer edge 404 of the rim 400. In the illustrated example, the lip 406 is approximately parallel to the blade 300. The lip 406 may provide additional control for a user to grip or hold the rim 400 between fingers or in hand.

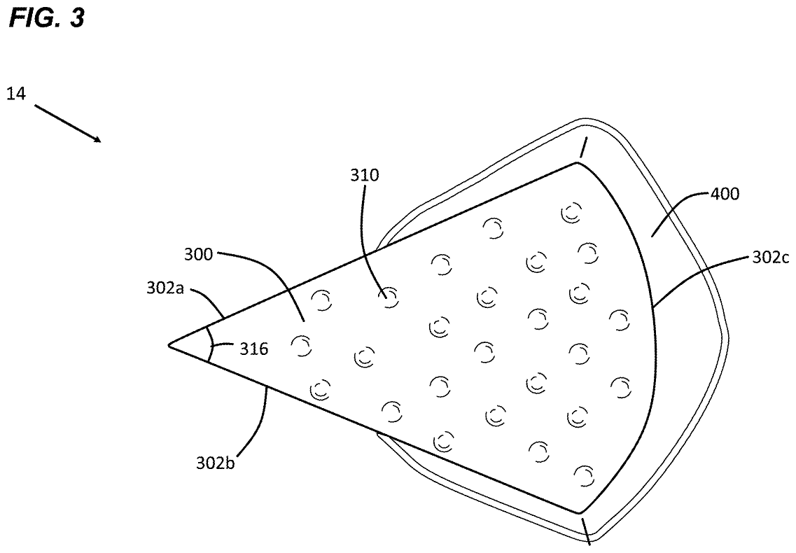

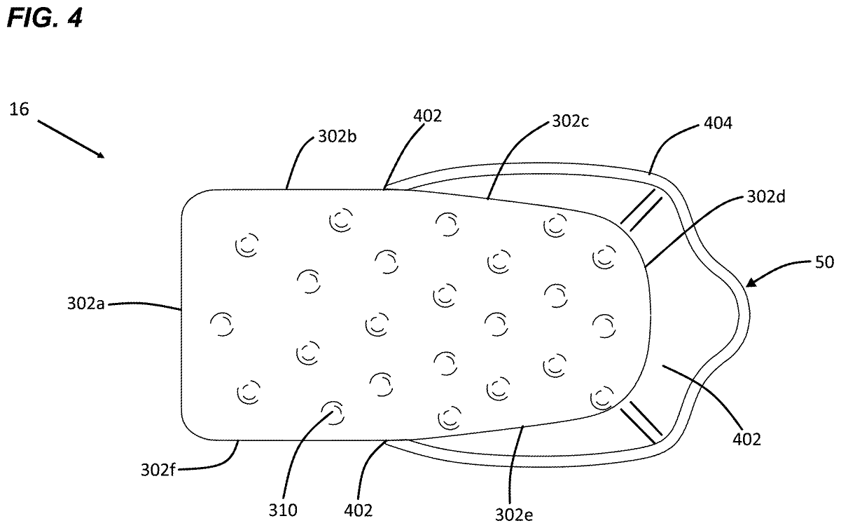

Now referring to FIGS. 3-4, other embodiments or variations or the article 10 will be illustrated and described. FIG. 3 is a top view of one exemplary example 14, which is a variation of the article 10. In the illustrated example, the article 14 includes a blade 300 and a rim 400. The blade 300 is approximately triangular and resembles a typical pizza slice in shape. The blade 300 comprises three sides 302 (302a, 302b and 302c). The side 302a and 302b are open and substantially straight, and the side 302c is curved upwardly in an angle and joined to the rim 400. The flat sides 302a and 302b form a corner 314 having an angle from about 20° to about 90°, or preferably from about 30° to about 60°. The corner 314 may be substantially rounded. The rim 400 extends from the side 302c and follows the upward curve thereof.

FIG. 4 is a top view of another exemplary example 16, which is a variation of the article 10. In the illustrated example, the article 16 includes a blade 300 and a rim 400. The article 16 has a substantially rectangular outline with six sides 302 (302a, 302b, 302c, 302d, 302e, and 302f). Similar to corner 316 of the article 14 of FIG. 3, the blade 300 has two corners 316 respectively formed by sides 302a/302b and 302a/302f. The two corners 316 may have an angle from about 60° to about 120°, preferably from about 80° to about 100°. The corners 316 may be substantially rounded.

FIG. 5 is a top view of another exemplary example 18, which is a variation of the article 10. In the illustrated example, the article 18 includes a blade 300, a rim 400, and a handle 500. The blade 300 has a plurality of flat and substantially straight sides 302 (302a, 302b, 302c, and 302d) opposed to the rim 400. The sides 302e, 302f, and 302g are curved upwardly. The rim 400 extends from the sides 302e, 302f, and 302g and follows the curves thereof. The flat sides (302a, 302b, 302c, and 302d) of the blade 300 provide a wide entrance to receive the food item that can easily slide into the article 18. The handle 500 extends and protrudes from the rim 400 along a center line 60 and provides a means for the user to hold/grip the article 10 securely by hand.

In some embodiments, the present article is made of cellulose, paper, paperboard, molded paper, pressed paper, polymer, post-consumer recycled paper or paperboard, post-consumer recycled polymer, plastic, aluminum, or a mixture thereof. The present article may be heat-resistant, oven safe, or microwave safe. For example, the present article can tolerate an oven-cooked hot food item having a temperature of above 400° F. for about at least 5 minutes without substantial deflection or deformation or break.

In some embodiments, the present article comprises a wet strength material. The “wet strength” used herein is a measure of how well the web of fibers holding the substrate together can resist a force of rupture when the substrate is wet or penetrated by liquid such as water or oil. Wet strength may be expressed as the ratio of wet to dry tensile force at break. When the article 10 is made of paper or paperboard, the paper or paperboard may include a wet strength additive to improve the wet strength of the paper or paperboard. The wet strength additive according to the present disclosure may include a wet strength agent or polymer capable of forming hydrogen bonds to the cellulose fibers, or capable of forming ionic bonds to the cellulose fibers, or capable of covalently bonding to the cellulose fibers. Examples of wet strength additives include but are not limited to polyamide polyamine-epichlorohydrin, melamine resin, melamine formaldehyde resin, urea-formaldehyde resin, polyamide, polyamide epoxy, polyvinylamine, and the like.

In some embodiments, the present article has a sufficient wet strength to hold and transfer a wet food item placed thereon without substantial deflection, deformation, or breakage. The food item (such as a pizza or a pizza slice) may have a weight from about at least about 4 oz, at least about 6 oz, at least about 8 oz, at least about 10 oz, at least 12 oz, at least 16 oz, at least 20 oz, at least 23 oz, or at least 25 oz. In some embodiments, the food item (e.g., the pizza or pizza slice) placed in the present article may have a weight from about 2 oz to about 32 oz, or from about 10 oz to about 28 oz, or from about 16 oz to about 24 oz.

As discussed above, the present article may be an integrated single-piece article with all parts thereof (e.g., blade, rim, handle) inseparable from each other. The present article may be manufactured by injection molding, paper molding, or paper pressing. In some embodiments, the present article may consist of 2 or more parts that can be easily assembled.

In some embodiments, the present article may be a single use article. In other embodiments, the present article is reusable or cleanable. In some embodiments, the present article is partially or entirely recyclable, compostable, degradable, and/or biodegradable.

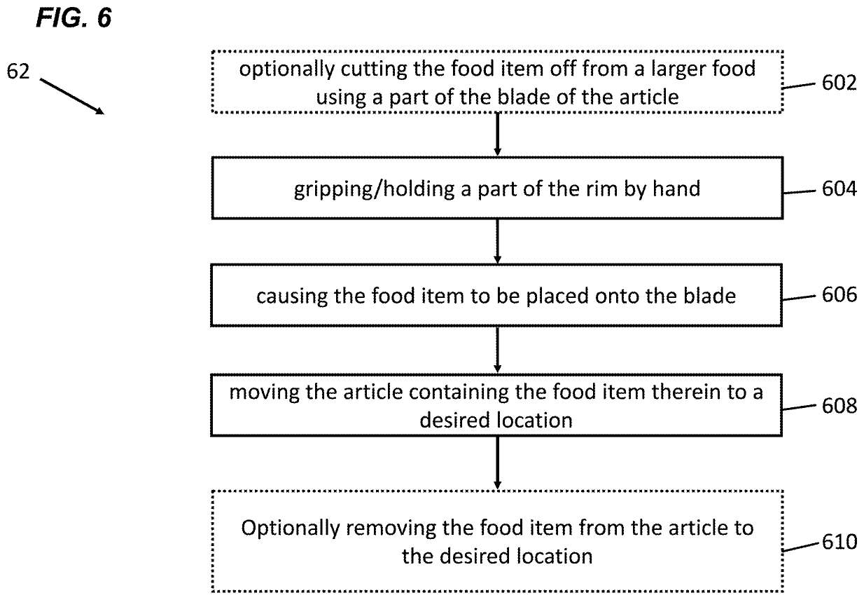

In another aspect, the present disclosure relates to methods of using any one of the article or a variation thereof described herein for handling or moving a food item. FIG. 6 shows a flow chart of one example method 60 that employs the article 12 of the present disclosure. In the illustrated example, the method 60 includes operations 604, 606, 608, and optionally 602 and 610. Operation 604 includes gripping or holding a part of the rim 400 or an additional handling member 50 (or a protruded handle 500 as shown in FIG. 5) of the article 12 by hand. Operation 606 includes causing the food item to be placed onto the blade. In certain embodiments, operation 606 includes sliding the blade under a food item to be moved to cause the food item to be received by the blade 300. Operation 608 includes moving the article 12 containing the food item therein by hand to a desired location.

In some embodiments, the method 60 further includes operation 602, which includes cutting the food item off from a larger food using a part of the blade 300 of the article 12, and moving the food item using the article 12. In certain embodiments, the method 60 further comprises cutting a pizza slice off from a whole pizza and moving the pizza slice using the article 12.

In some embodiments, the method 60 further includes operation 610. Operation 610 includes removing the food item from the article to the desired location. In certain embodiments, operation 610 includes sloping the article 12 by hand to cause the food item placed therein to slide off from the article 12 through a flat side 302 of the blade 300 to the desired location, without contacting the food item by hand.

In some embodiments, the method is executed by only one hand. In some embodiments, the food item is free from contacting the hand throughout the execution of the method. In some embodiments, the food item is a whole pizza or a part thereof or a pizza slice.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. An article for receiving or holding a food item comprising:
a. a blade; and
b. a rim extending along at least one side of the blade.

2. The article of claim 1, wherein the blade is flat or substantially flat.

3. The article of claim 1, wherein the blade has one side.

4. The article of claim 1, wherein the blade has three sides.

5. The article of claim 1, wherein the blade has four sides.

6. The article of claim 1, wherein the blade has five sides.

7. The article of claim 1, wherein at least one side of the blade is open.

8. The article of claim 1, wherein the blade comprises two flat sides and two curved sides and the rim follows the shape of the curve on at least one side of the blade.

9. The article of claim 8, wherein the rim extends from the curved sides of the blade to an outer edge elevated from the blade, and wherein the rim forms an angle relative to the blade.

10. The article of claim 1, wherein the blade further comprises a top surface and a bottom surface.

11. The article of claim 10, further comprising a plurality of projections disposed on the top surface, the bottom surface, or both.

12. The article of claim 10, further comprising a plurality of recesses disposed on the top surface, the bottom surface, or both.

13. The article of claim 10, further comprising a protective coating or a decorative coating disposed on at least a portion of the top surface, the bottom surface, or both.

14. The article of claim 1, wherein the rim extends along a portion of at least two sides of the blade.

15. The article of claim 1, wherein the rim has a first height and a second height relative to the blade, and the first height and the second height are not the same.

16. The article of claim 1, further comprising a lip extending from the top edge of the rim.

17. The article of claim 16, wherein the lip is substantially parallel to the blade.

18. The article of claim 1, the rim further comprising a depression, a plurality of projections, a plurality of recesses, or a combination thereof.

19. The article of claim 1, wherein the article is a pizza peel.

20. The article of claim 1, wherein the article is made of cellulose, paper, paperboard, molded paper, polymer, post-consumer recycled paper or paperboard, post-consumer recycled polymer, aluminum, or a mixture thereof.

21. The article of claim 1, wherein the article is intended for single use.

22. The article of claim 1, wherein the article comprises a wet strength agent or polymer.

23. The article of claim 1, wherein the article is configured to hold a wet food item of at least 8 oz without substantial deflection, deformation, or break.

24. A pizza peel comprising:
a. a blade comprising a plurality of sides, a top surface, and a bottom surface;
b. a plurality of projections or recesses on the top surface, the bottom surface, or both; and
c. a rim extending along at least two sides of the blade.

25. The pizza peel of claim 24, wherein the rim extends along a portion of at least four sides of the blade.

26. The pizza peel of claim 24, wherein the rim has a first height and a second height relative to the blade and the first height and the second height are not the same.

27. The pizza peel of claim 24, further comprising a lip extending from the top of the rim.

28. The pizza peel of claim 27, wherein the lip is substantially parallel to the blade.

29. The pizza peel of claim 24, the rim further comprising a depression, a plurality of projections, a plurality of recesses, or a combination thereof.

30. The pizza peel of claim 24, wherein the pizza peel is made of cellulose, paper, paperboard, molded paper, polymer, post-consumer recycled paper or paperboard, post-consumer recycled polymer, aluminum, or a mixture thereof.

31. The pizza peel of claim 24, wherein the pizza peel is configured to hold a wet food item of at least 24 oz without substantial deflection, deformation, or breakage.

32. A method of handling a food item using an article comprising a blade and a rim extending along at least one side of the blade, the method comprising:
a. gripping or holding a part of the rim by hand;
b. causing the food item to be placed onto the blade; and
c. moving the article containing the food item therein to a desired location.

33. The method of claim 32, further comprising: cutting the food item off from a larger food using a part of the blade of the article, and moving the pizza slice using the article.

34. The method of claim 32, further comprising: sloping the article to cause the food item placed therein to slide off from the article through a flat side of the blade to the desired location.

35. The method of claim 32, wherein the steps of the method are performed by one hand.

36. The method of claim 32, wherein the food item is free from contacting the hand throughout the operation.

37. The method of claim 32, wherein the food item is a pizza or a part thereof or a pizza slice.
